(19) United States
(12) Patent Application Publication
(10) Pub. No.: US 2018/0007528 A1
(43) Pub. Date: Jan. 4, 2018

(54) METHOD, APPARATUS AND SYSTEM

(71) Applicant: NOKIA SOLUTIONS AND NETWORKS OY, Espoo (FI)

(72) Inventors: Karol DRAZYNSKI, Wroclaw (PL); Maciej JANUSZEWSKI, Pila (PL); Ali YAVER, Wroclaw (PL); Frank FREDERIKSEN, Klarup (DK); Patrick MARSCH, Wroclaw (PL)

(73) Assignee: NOKIA SOLUTIONS AND NETWORKS OY, Espoo (FI)

(21) Appl. No.: 15/542,914

(22) PCT Filed: Jan. 14, 2015
(86) PCT No.: PCT/EP2015/050531

§ 371 Date: Jul. 11, 2017

(51) Int. Cl. H04W 8/00; H04W 76/02

(52) U.S. Cl. CPC H04W 8/005; H04W 76/023

(57) ABSTRACT

An example method may include providing parameter information for use by a user equipment in device to device discovery, the user equipment including one of the devices, the parameter information determined in dependence on user equipment context information and using the parameter information to determine a set of parameters for use by the user equipment in discovery of another device.

### FIELD

The present application relates to a method, apparatus and system and in particular but not exclusively, device-to-device (D2D) communications in 5G systems.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include mobile networks, satellite based communication systems and different wireless local networks, for example wireless local area networks (WLAN). Mobile networks can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

### SUMMARY

In a first aspect, there is provided a method comprising providing parameter information for use by a user equipment in device to device discovery, said user equipment comprising one of said devices, said parameter information determined in dependence on user equipment context information and using said parameter information to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said determining may comprise at least one of selecting a set of parameters from sets of parameters stored in the user equipment, selecting a set of parameters from sets of parameters received from a network node and modifying at least one parameter of a set of parameters.

Said set of parameters may include at least one of absolute values or offset values.

The method may comprise providing user equipment context information to the other device in the device to device discovery process.

In a second aspect, there is provided a method comprising controlling receiving user equipment context information from a user equipment, providing parameter information for use by a user equipment in device to device discovery, said user equipment comprising one of said devices, said parameter information determined in dependence on the user equipment context information and wherein said parameter information is to be used to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said set of parameters may include at least one of absolute values and offset values.

In a third aspect, there is provided an apparatus, said apparatus comprising means for providing parameter information for use by a user equipment in device to device discovery, said user equipment comprising one of said devices, said parameter information determined in dependence on user equipment context information and means for using said parameter information to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said means for determining may comprise at least one of means for selecting a set of parameters from sets of parameters stored in the user equipment, means for selecting a set of parameters from sets of parameters received from a network node and means for modifying at least one parameter of a set of parameters.

Said set of parameters may include at least one of absolute values or offset values.

The apparatus may comprise means for providing user equipment context information to the other device in the device to device discovery process.

In a fourth aspect, there is provided an apparatus, said apparatus comprising means for comprising controlling receiving user equipment context information from a user equipment, providing parameter information for use by a user equipment in device to device discovery, said user equipment comprising one of said devices, said parameter information determined in dependence on the user equipment context information and wherein said parameter information is to be used to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said set of parameters may include at least one of absolute values and offset values.

In a fifth aspect there is provided an apparatus, said apparatus comprising at least one processor and at least one memory including a computer program code, the at least one memory and the computer program code configured to, with the at least one processor, cause the apparatus at least to provide parameter information for use by a user equipment in device to device discovery, said user equipment comprising one of said devices, said parameter information determined in dependence on user equipment context information; and use said parameter information to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

The apparatus may be configured to, at least one of, select a set of parameters from sets of parameters stored in the user equipment, select a set of parameters from sets of parameters received from a network node and modify at least one parameter of a set of parameters.

Said set of parameters may include at least one of absolute values or offset values.

Said apparatus may be configured to provide user equipment context information to the other device in the device to device discovery process.

In a sixth aspect, there is provided an apparatus, said apparatus comprising at least one processor and at least one memory including a computer program code, the at least one memory and the computer program code configured to, with the at least one processor, cause the apparatus at least to control receiving user equipment context information from a user equipment, provide parameter information for use by a user equipment in device to device discovery, said user equipment comprising one of said devices, said parameter information determined in dependence on the user equipment context information and wherein said parameter information is to be used to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said set of parameters may include at least one of absolute values and offset values.

In a seventh aspect there is provided a computer program embodied on a non-transitory computer-readable storage medium, the computer program comprising program code for controlling a process to execute a process, the process comprising providing parameter information for use by a user equipment in device to device discovery, said user equipment comprising one of said devices, said parameter information determined in dependence on user equipment context information and using said parameter information to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said determining may comprise at least one of selecting a set of parameters from sets of parameters stored in the user equipment, selecting a set of parameters from sets of parameters received from a network node and modifying at least one parameter of a set of parameters.

Said set of parameters may include at least one of absolute values or offset values.

The method may comprise providing user equipment context information to the other device in the device to device discovery process.

In an eighth aspect there is provided a computer program embodied on a non-transitory computer-readable storage medium, the computer program comprising program code for controlling a process to execute a process, the process comprising controlling receiving user equipment context information from a user equipment, providing parameter information for use by a user equipment in device to device discovery, said user equipment comprising one of said devices, said parameter information determined in dependence on the user equipment context information and wherein said parameter information is to be used to determine a set of parameters for use by said user equipment in discovery of another device.

User equipment context information may comprise at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

Said set of parameters may comprise a radio resource management profile.

Said set of parameters may comprise parameters including at least one of transmission power, transmission periodicity, modulation, coding, physical resources, protocols, update frequency and time slots.

Said set of parameters may include at least one of absolute values and offset values.

In a ninth aspect there is provided a computer program product for a computer, comprising software code portions for performing the steps of any one of the first and second aspects when said product is run on the computer.

In the above, many different embodiments have been described. It should be appreciated that further embodiments may be provided by the combination of any two or more of the embodiments described above.

### LIST OF DRAWINGS

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a flowchart of an example method of determining a discovery scheme;

FIG. 4 shows a flowchart of an example method of determining a discovery scheme;

FIG. 5 shows an example schematic diagram of a communication between a device and a cellular network;

FIG. 6 shows a schematic diagram of an example control apparatus;

FIG. 7 shows a schematic diagram of an example apparatus;

FIG. 8 shows a schematic diagram of an example apparatus;

### DESCRIPTION OF SOME EMBODIMENTS

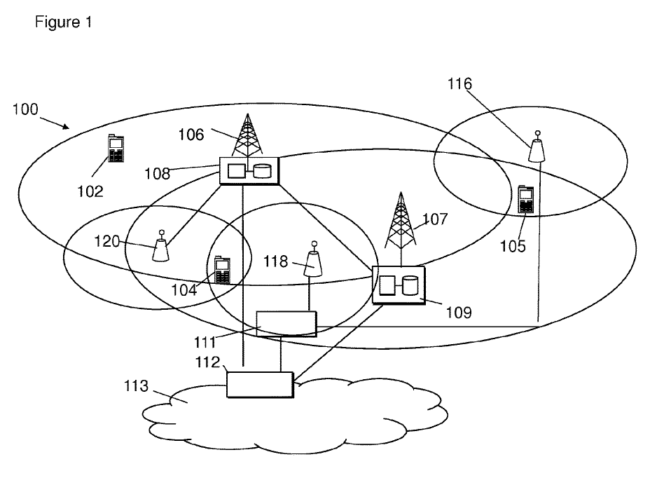

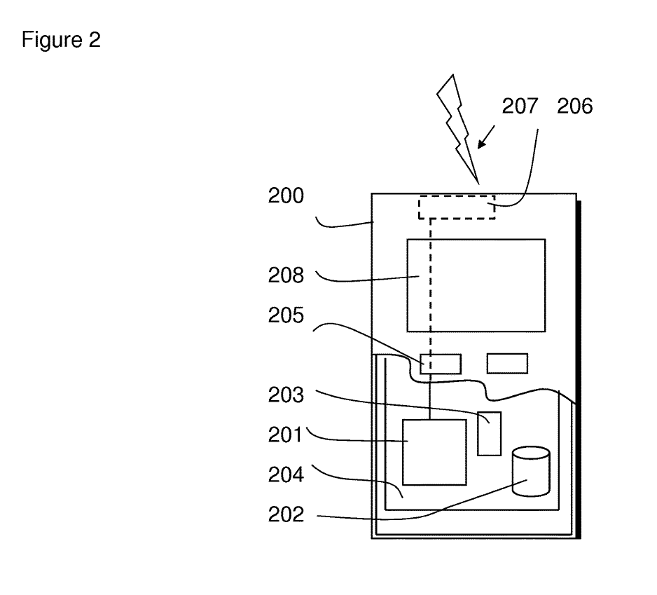

Before explaining in detail the examples, certain general principles of a wireless communication system and mobile communication devices are briefly explained with reference to exemplifying FIGS. 1 to 2 to assist in understanding the technology underlying the described examples.

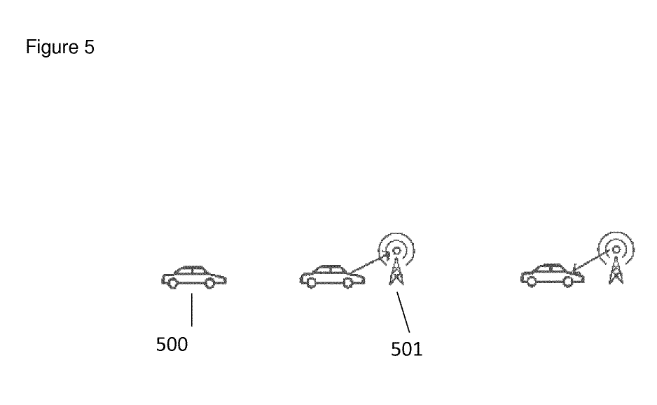

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 5.

LTE systems may however be considered to have a so-called “flat” architecture, without the provision of Radio Network Controllers (RNCs); rather the (e)NB is in direct communication with the core network, namely system architecture evolution gateway (SAE-GW) and mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations or nodes 106 and 107 are shown as connected to a wider communications network 113 via gateway 112. A further gateway function may be provided to connect to another network.

The smaller base stations or nodes (access nodes) 116, 118 and 120 may also be connected to the network 113, for example by a separate gateway function and/or via the controllers of the macro level stations. The base stations 116, 118 and 120 may be pico or femto level base stations, a relaying device, a road side unit or the like. In the example, stations 116 and 118 are connected via a gateway 111 whilst station 120 connects via the controller apparatus 108. In some embodiments, the smaller stations may not be provided.

The embodiments are not, however, restricted to the system given as an example but a person skilled in the art may apply the solution to other communication systems provided with necessary properties. Another example of a suitable communications system is the 5G concept. The exact details of 5G implementation are however not yet known at the stage of writing this application. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface or other wireless interface facility (e.g., USB dongle), personal data assistant (PDA) or a tablet (laptop, touch screen computer) provided with wireless communication capabilities, or any combinations of these or the like. Some other examples of user devices (UE) are a game console, notebook, multimedia device and a device using a wireless modem (alarm or measurement device, etc.). A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided.

Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

Vehicular to vehicular applications in 5G are or a part of Machine Type Communication (MTC). 5G MTC may be the enabler of both direct and indirect (e.g. with the involvement of a cellular network) car-to-car communication. Usage of vehicle-to-vehicle (V2V) communication in the MTC context may be for increased safety, automated driving, localization of other road users and other suitable means which can be utilized for automation of machine specific vehicle to vehicle communication.

As specified in the METIS Intermediate Report 1.5, section 12 “Traffic efficiency and safety” a moving device for MTC type of communication may have a defined communication range depended on the environment it is currently in.

The required communication range may be different for different environments. For example, in highway scenarios, the required communication range may be up to 1 km, in rural scenarios the required communication range may be up to 500 m and in urban scenarios the required communication range may be up to 300 m. It may be desirable to define how a device for MTC type of traffic shall initiate, perform or terminate MTC in different environments.

Two of the biggest enablers of MTC traffic may be high reliability and low latency. Factors may be a fast vehicle-vehicle or vehicle-network-vehicle discovery procedure which would enable MTC.

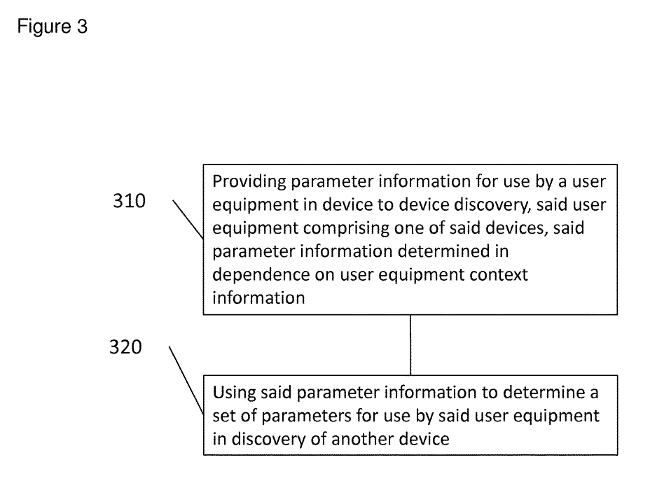

FIG. 3 depicts a method of determining a device discovery and communication scheme according to the current context of a UE. The method comprises, in a first step 310 providing parameter information for use by a user equipment in device to device discovery, said user equipment comprising one of said devices, said parameter information determined in dependence on user equipment context information and in a second step 320, using said parameter information to determine a set of parameters for use by said user equipment in discovery of another device. The set of parameters may comprise a device discovery and information scheme, or radio resource management profile. A method such as that of FIG. 3 may provide a method for discovering and classifying vehicles with or without direct support from network based on their context, taking into account the requirements posed on the communication range and UE context.

A method such as that shown in FIG. 3 may be performed at a user equipment. If a device is not under network coverage, the device itself may determine which MTC discovery and/or communication scheme is to be used using context information of the device.

A UE may determine its own current location and/or context. This information may be based on user equipment information such as, among others, GPS (global positioning system) location, UE position related to other UEs, network elements, specific Point-Of-Interest, UE geographical environment, information obtained from various sensors or any combination of these factors.

In one example policy for a UE not under network coverage, which V2V discovery scheme to use under which conditions may be dictated by the last AP the device had a connection to. Another option is that V2V discovery policies may be standardized and stored within a UE. Yet another option is that V2V discovery policies may be pushed to UEs from special dedicated APs (for instance macro nodes) and may be kept while the UE is out of coverage from these dedicated Aps.

For a device under network coverage, the device may signals its MTC capabilities and/or context information only available to itself (e.g. UE speed, PDP, communication context etc.) to the network.

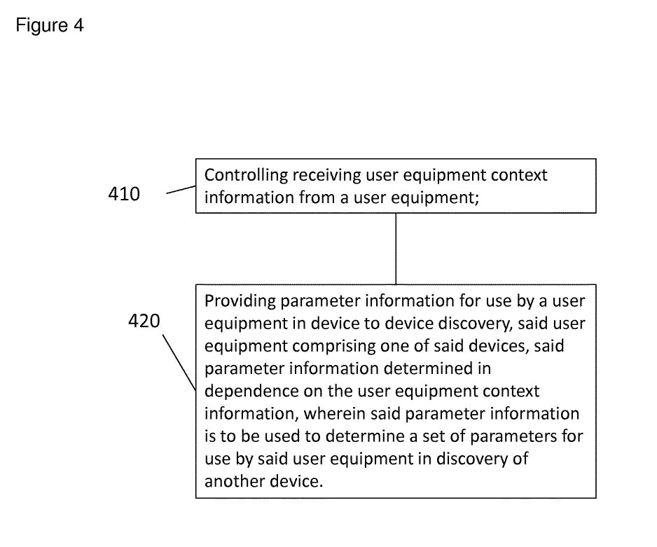

FIG. 4 depicts an example method of determining a device discovery and communication scheme according to the current context of a UE. The method comprises, in a first step 410, controlling receiving user equipment context information from a user equipment, providing parameter information for use by a user equipment in device to device discovery, said user equipment comprising one of said devices, said parameter information determined in dependence on the user equipment context information and wherein said parameter information is to be used to determine a set of parameters for use by said user equipment in discovery of another device.

FIG. 5 shows a schematic diagram of an example method of determining a UE context. A device 500, before starting MTC D2D driven type of communication communicates with a node 501 of a cellular network. In this type of information exchange/broadcast between the UE and cellular network the network responds to the UE with the appropriate context which shall be used in the subsequent MTC related communication. This trigger for network based assignment of UE type of context can be a UE originated request. This request may contain user equipment information, e.g. information related to UE position (like e.g. GPS coordinates), movement related information, UE type, etc. As a result the UE may be configured to perform MTC communication according to the environment it is currently in.

Based on information from all the UEs in a certain area, the network may decides which MTC discovery/communication policy to use and sends this to the UE(s). Sending MTC discovery/communication policy information to UE(s) may be done in broadcast fashion (e.g. same policy for all UEs, in this case this information may also be contained in the system information blocks SIBs) or may be dedicated to one UE,

In some cases, flexibility and/or empowerment may be given to the UE within the policy dictated by the network. For example: the policy may allow the UE in exceptional circumstances—for instance a public safety relevant incident—to use a higher D2D transmit power or other suitable resource.

Alternatively, or in addition, for a device under network coverage, a device may assess its own environment based on the information available to it and chooses its V2V discovery context. A device may signal only the selected context information to the network. The network may acknowledge or change the device's decision regarding the chosen discovery policy. A UE may self assess context estimation with additional confirmation/assessment from a cellular network.

Regardless of whether the discovery scheme is chosen by the network or by the device the selection can be based on any of the following user equipment context information, either alone or in combination.

The context information may comprise GPS coordinates. The context information may comprise available maps. Based on the coordinates and maps the type of a road may be established i.e. highway vs. slower road.

The context information may comprise information obtained from various sensors and other users in the device vicinity. For example, information obtained from sensors and other means may include the UE speed and direction of movement.

Context information may comprise information obtained from the cellular network. The cellular network may play an assisting role in UE localization and may act as a passive or active party in this role. There are several possibilities as to how information from the cellular network may be used. To determine its environment the UE may: sense the number of Base-stations (BSs) and/or Access Points (APs) in a particular area as well as the distance between them, detect the location information which may be broadcasted by the surrounding BSs/APs (those may be e.g. GPS co-ordinates and/or “location/profile type” information, etc.) and/or use dedicated Rode Side Units (RSU) network elements in UE localization.

Context information may comprise an environment profile. Environment profile may be assessed by determining the power delay profile or channel variations for speed estimation,

The UE may use any combination of the abovementioned information and means, or any other suitable means, in determining a discovery scheme.

Once the current UE environment is known, the UE may adjust its radio resource management (RRM) profile for the transmission based on the parameter information. For example, the UE may adjust the beacon signal power that will be used at other devices for discovery purposes, the signal power that will be broadcasted to other devices for communicating current MTC related information, the update frequency of the broadcast or beacon signals that could be a function of a UE speed, different coding scheme or resource utilization strategies may be used depending on the UE context.

Allocated physical radio resources e.g. different time/frequency bands may be reserved for different context profiles. Allocated physical radio resources may include, among others, frequency bands, time, power, code resources, different coding schemes, protocols to be used and potentially a combination of these. A given environment profile can mean a different set of resources to be used, for example, for beacon transmission, device-to-device communication, etc. Allocated radio resources assigned to different UE contexts may also be scheduled in a semi-persistent way.

The transmission power and the periodicity of broadcast messages used for this type of communication shall be scaled according to the scenario defined by the UE. For example, in a highway environment the highest power and the highest frequency (i.e. number of occurrences) of an update and/or beacon signal may be used, and other parameters that apply may also be scaled to a highway environment. The lowest power/bandwidth/update frequency etc. may be reserved for urban and/or a mid-power/bandwidth/update frequency etc. may be allocated to rural environment.

The UE context information may be broadcast to other devices during the discovery procedure. That is, the environment that has been assessed may be shared with other MTC devices.

A method such as that described above may satisfy the need for efficient MTC discovery and subsequent communication depended on the current UE environment. A UE on e.g. a highway will broadcast its discovery signal with the highest power and highest transmission periodicity (meaning with the highest number of occurrences of a the signal in a given time unit) enabling other fast moving devices to be discovered and communicated with. More robust modulation and coding schemes may also be used than for e.g. a UE in an urban or rural environment. The piece of information informing other devices about a device's current environment (i.e. context) will enable them to choose whether to respond or not this message. For instance, a device in rural environment (e.g. on a local road along the highway) might not start communication with a highway device passing next-by for MTC specific communication.

A mechanism characterized by RRM profile may specify how devices belonging to different mobility profiles communicate with each other. For example a slow moving device may need to communicate with a highway device at a different transmission power compared to a device with similar mobility profile. The number of parameters may include, among others, transmission power, coding, modulation, physical resources, protocols, update frequency, time slots, any other suitable parameter and combination of these parameters and may be bound to a given RRM profile combination.

Different RRM profiles may enable a UE to communicate with a single or multiple UEs configured with a different mobility profile. The set of parameters may be unique for all possible combinations of defined mobility profiles. These sets of parameters may be signalled explicitly by the AP or they may be pre-programmed in the UE. Moreover, the parameters may constitute absolute values or they can be defined as offsets which differentiate them from parameters of the same profile. Since UEs with different profiles may also belong to different cells, the mechanism may also be extended to multiple APs. In the case of UEs under multiple APs, the APs may facilitate the exchange of the parameters for each of the combinations between themselves and to the subject UEs.

The above method may provide automatic adjustment of device discovery and communication scheme/mode according to the current context of the originating UE. As a result, MTC may be easier to establish and perform. The correct assessment of communication type to be used in the current UE environment may improve transmission reliability and latency. Those two factors are important for correct MTC type of communication in a V2V transmission scheme.

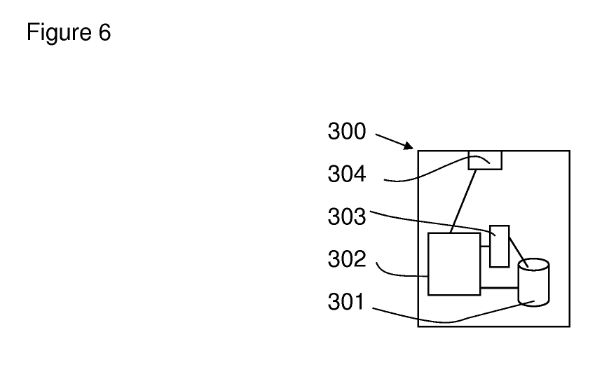

Embodiments described above by means of FIGS. 1 to 5 may be implemented on an apparatus, such as a node, host or server, or in a unit, module, etc. providing control functions as shown in FIG. 6 or on a mobile device (or in a unit, module etc. in the mobile device) such as that of FIG. 2. FIG. 6 shows an example of such an apparatus. In some embodiments, a base station comprises a separate unit or module for carrying out control functions. In other embodiments, the control functions may be provided by another network element such as a radio network controller or a spectrum controller. The apparatus 300 may be arranged to provide control on communications in the service area of the system. The apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the apparatus 300 may be configured to execute an appropriate software code to provide the control functions. Control functions may include at least providing parameter information for use by a user equipment in device to device discovery, said user equipment comprising one of said devices, said parameter information determined in dependence on user equipment context information and using said parameter information to determine a set of parameters for use by said user equipment in discovery of another device. Alternatively, or in addition, control functions may include controlling receiving user equipment context information from a user equipment, providing parameter information for use by a user equipment in device to device discovery, said user equipment comprising one of said devices, said parameter information determined in dependence on the user equipment context information, wherein said parameter information is to be used to determine a set of parameters for use by said user equipment in discovery of another device.

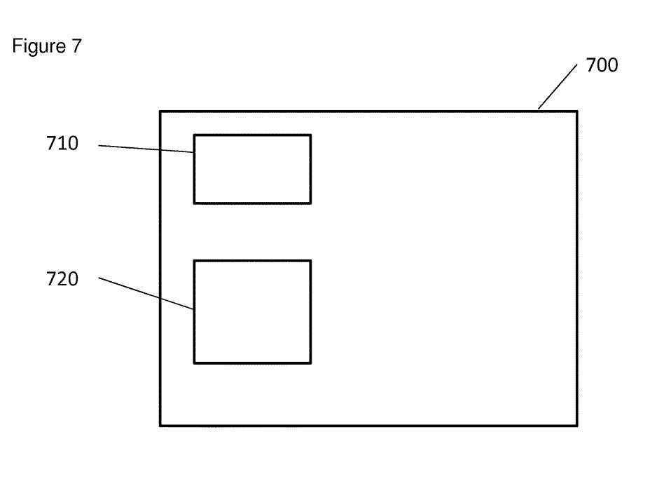

An example of an apparatus 700, as shown in FIG. 7, may comprise means 710 for providing parameter information for use by a user equipment in device to device discovery, said user equipment comprising one of said devices, said parameter information determined in dependence on user equipment context information and means 720 for using said parameter information to determine a set of parameters for use by said user equipment in discovery of another device.

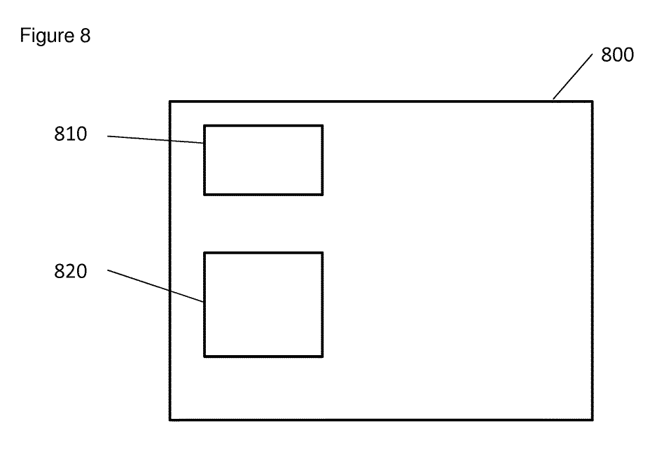

An example of an apparatus 800 as shown in FIG. 8, may comprise means 810 for controlling receiving user equipment context information from a user equipment, means 820 for providing parameter information for use by a user equipment in device to device discovery, said user equipment comprising one of said devices, said parameter information determined in dependence on the user equipment context information, wherein said parameter information is to be used to determine a set of parameters for use by said user equipment in discovery of another device.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to 5G, similar principles can be applied to any other communication system or radio access technology. Embodiments are generally applicable for MTC, or device-to-device communication. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 5 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 5 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
providing parameter information for use by a user equipment in device to device discovery, said user equipment comprising one of said devices, said parameter information determined in dependence on user equipment context information; and
using said parameter information to determine a set of parameters for use by said user equipment in discovery of another device.

2.-7. (canceled)

8. A method comprising:
controlling receiving user equipment context information from a user equipment;
providing parameter information for use by a user equipment in device to device discovery, said user equipment comprising one of said devices, said parameter information determined in dependence on the user equipment context information; and
wherein said parameter information is to be used to determine a set of parameters for use by said user equipment in discovery of another device.

9.-14. (canceled)

15. An apparatus comprising:
at least one processor and at least one memory including a computer program code, the at least one memory and the computer program code configured to, with the at least one processor, cause the apparatus at least to:
provide parameter information for use by a user equipment in device to device discovery, said user equipment comprising one of said devices, said parameter information determined in dependence on user equipment context information; and
use said parameter information to determine a set of parameters for use by said user equipment in discovery of another device.

16. An apparatus according to claim 15, wherein the user equipment context information comprises at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

17. An apparatus according to claim 15, wherein said set of parameters comprises a radio resource management profile.

18. An apparatus according to claim 15, wherein said set of parameters comprises parameters including at least one of transmission power, transmission periodicity, modulation, coding, physical resources, protocols, update frequency and time slots.

19. An apparatus according to claim 15 configured to, at least one of: select a set of parameters from sets of parameters stored in the user equipment, select a set of parameters from sets of parameters received from a network node and modify at least one parameter of a set of parameters.

20. An apparatus according to claim 15, wherein said set of parameters includes at least one of absolute values or offset values.

21. An apparatus according to claim 15 configured to:
provide user equipment context information to the other device in the device to device discovery process.

22. An apparatus comprising:
at least one processor and at least one memory including a computer program code, the at least one memory and the computer program code configured to, with the at least one processor, cause the apparatus at least to:
control receiving user equipment context information from a user equipment;
provide parameter information for use by a user equipment in device to device discovery, said user equipment comprising one of said devices, said parameter information determined in dependence on the user equipment context information; and
wherein said parameter information is to be used to determine a set of parameters for use by said user equipment in discovery of another device.

23. An apparatus according to claim 22, wherein the user equipment context information comprises at least one of user equipment geographic location, user equipment environment information, user equipment speed, user equipment direction of motion measurement, network information, power delay profile, interference level, number of base-stations available to the user equipment, number of devices available to the user equipment, channel variations and radio parameters measured by the user equipment.

24. An apparatus according to 22, wherein said set of parameters comprises a radio resource management profile.

25. An apparatus according to claim 22, wherein said set of parameters comprises parameters including at least one of transmission power, transmission periodicity, modulation, coding, physical resources, protocols, update frequency and time slots.

26. An apparatus according to claim 22, wherein said set of parameters includes at least one of absolute values and offset values.
